(19) United States
(12) Patent Application Publication
(10) Pub. No.: US 2013/0231072 A1
(43) Pub. Date: Sep. 5, 2013

(54) EMERGENCY CALL SYSTEM AND METHOD FOR MOBILE PHONES

(71) Applicants: Bryan Anderson, Carmel, IN (US); Jack Behar, Cypress, TX (US); Gary Graves, Cypress, TX (US)

(72) Inventors: Bryan Anderson, Carmel, IN (US); Jack Behar, Cypress, TX (US); Gary Graves, Cypress, TX (US)

(21) Appl. No.: 13/763,668

(22) Filed: Feb. 9, 2013

Related U.S. Application Data
(60) Provisional application No. 61/597,265, filed on Feb. 10, 2012.

(51) Int. Cl. H04W 4/22

(52) U.S. Cl. CPC H04W 4/22
USPC 455/404.1

(57) ABSTRACT

Technologies for handling emergency calls from mobile communication devices include receiving an emergency call originated by a mobile communication device to a land line number serviced by an emergency call handling server, determining an emergency call center to handle the emergency call based on the called land line number, and routing the emergency call to the determined emergency call center. The land line number may have a pre-defined location associated therewith.

### CROSS-REFERENCE TO RELATED U.S. PATENT APPLICATION

This application claims priority under 35 U.S.C. §119(e) to U.S. Provisional Application Ser. No. 61/597,265, filed Feb. 10, 2012, which is expressly incorporated by reference herein.

### TECHNICAL FIELD

The present disclosure relates to telephony software and systems. More specifically, the present disclosure relates to emergency call software and systems for mobile phones.

### BACKGROUND

Most locations have public emergency call systems with which a person in an emergency situation can call to receive help. Generally, such systems include a public short call number that is connected to an emergency call center having a human operator who can immediately activate an emergency service, e.g. a police call, a fire department alert, or an ambulance. Traditionally in land line systems, the human operator inherently knows the location of the caller as the telephone carrier provides the physical location of the telephone, typically in the form of an on-line data connection between the incoming caller ID and the telephone carrier location information database.

Such public emergency systems work well for land lines but have inherent difficulties with mobile telephones. In the United States, in which the 911 telephone number is the traditional emergency number, regulations have been created that require all mobile telephone operators to attempt to track the location of the mobile phone. With such a system, the human operator of the emergency number is informed of the location of the 911 mobile caller by the mobile carrier. Unfortunately, the location information is only approximate so that the exact physical location of the caller is not known and delays in determining such location information may be experienced.

### SUMMARY

Accordingly to one aspect, a method for handling an emergency call includes receiving, with an emergency call handling server, an emergency call originated by a mobile communication device to a land line number serviced by the emergency call handling server, the land line number having a pre-defined location associated therewith; determining, with the emergency call handling server, an emergency call center to receive the emergency call based on the land line number; and routing the emergency call to the selected emergency call center using the land line number.

In some embodiments, receiving the emergency call may include receiving an emergency call to a land line number mapped to a particular emergency type. Additionally, determining the emergency call center may include determining the emergency call center based on the emergency type mapped to the land line number. Further, in some embodiments, determining the emergency call center may include comparing the land line number called by the mobile communication device to a location mapping database. In such embodiments, the location mapping database may map land line numbers to pre-defined locations. Additionally, in some embodiments, routing the emergency call may include conveying the pre-defined location to the emergency call center using the land line number.

In some embodiments, the method may further include sing receiving additional emergency information related to an emergency prompting the emergency call from the mobile communication device and supplying the additional emergency information to the emergency call center. Additionally, the method may include determining whether the mobile communication device is authorized to originate the emergency call using the land line number and disconnecting the emergency call prior to routing the emergency call to the selected emergency call center in response to determining that the mobile communication device is not authorized to originate the emergency call using the land line number.

Yet further, the method may also include determining, with the emergency call handling server, an entity to notify by comparing a cellular telephone number of the mobile communication device to a notification policy stored on the emergency call handling server, the notification policy mapping incoming cellular telephone numbers to entities to be notified and notifying the determined entity in response to receiving the emergency call. In some embodiments, the determining the entity to notify may include comparing the land line number to the notification policy.

Additionally, in some embodiments, determining the emergency call center to receive the emergency call may include determining a first emergency call center to receive the emergency call. In such embodiments, the method may also include receiving, with the emergency call handling server, a second emergency call originated by the mobile communication device to a second land line number; determining, with the emergency call handling server, a second emergency call center to receive the second emergency call based on the second land line number; and routing the second emergency call to the second emergency call center using the second land line number. In some embodiments, the second land line number may be associated with the pre-defined location. Alternatively, in some embodiments, the second land line number may be associated with a second pre-defined location different from the pre-defined location associated with the first land line number.

According to another aspect, an emergency call handling server to handle emergency calls originated from mobile communication devices may include a communication module and an emergency call routing module. The communication module may be to receive an emergency call originated by the mobile communication device to a land line number serviced by the emergency call handling server. The land line number may have a pre-defined location associated therewith. The emergency call routing module may be to (i) determine an emergency call center to receive the emergency call based on the land line number and (ii) route the emergency call to the selected emergency call center using the land line number.

In some embodiments, to receive the emergency call may include to receive an emergency call to a land line number mapped to a particular emergency type and to determine the emergency call center may include to determine the emergency call center based on the emergency type mapped to the land line number. Additionally, in some embodiments, the emergency call handling server may further include a location mapping database that maps land line numbers to pre-defined locations. In such embodiments, the emergency call routing module is to compare the land line number called by the mobile communication device to the location mapping database to determine the emergency call center.

Additionally, in some embodiments, the emergency call routing module is further to determine whether the mobile communication device is authorized to originate the emergency call using the land line number and disconnect the emergency call prior to routing the emergency call to the selected emergency call center in response to a determination that the mobile communication device is not authorized to originate the emergency call using the land line number. Additionally, in some embodiments, the emergency call handling server may further include a notification policy that maps incoming cellular telephone numbers to entities to be notified. In such embodiments, the emergency call routing module is further to (i) determine an entity to notify by comparison of a cellular telephone number of the mobile communication device to the notification policy and (ii) notify the determined entity in response to receipt of the emergency call.

Yet further, in some embodiments, the emergency call may be embodied as a first emergency call, the land line number may be embodied as a first land line number, and the emergency call center may be embodied as a first emergency call center. In such embodiments, the communication module is further to receive a second emergency call originated by the mobile communication device to a second land line number. Additionally, in such embodiments, the emergency call routing module is further to (i) determine a second emergency call center to receive the second emergency call based on the second land line number and (ii) route the second emergency call to the second emergency call center using the second land line number. In some embodiments, the second land line number may be associated with the pre-defined location. Alternatively, in some embodiments, the second land line number may be associated with a second pre-defined location different from the pre-defined location associated with the first land line number.

According to a further aspect, a method for originating an emergency call on a mobile communication device may include displaying a plurality of location identifications on a display of the mobile communication device, each location identification being associated with a corresponding location; receiving, with the mobile communication device, a user selection of one of the location identifications; determining, with the mobile communication device, a plurality of emergency type identifications based on the selected location identification, each emergency type identification having a non-public-emergency land line number associated therewith; displaying the plurality of emergency type identifications on the display of the mobile communication device; receiving a user selection of one of the emergency type identifications; and originating a call to the non-public-emergency land line number associated with the selected emergency type identification to complete an emergency call.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of a system for handling emergency calls from a mobile communication device;

FIG. 2 is a simplified block diagram of a mobile communication device of the system of FIG. 1;

FIG. 3 is a simplified block diagram of an environment of the mobile communication device of FIG. 2;

FIG. 4 is a simplified block diagram of an emergency call handling server of the system of FIG. 1;

FIG. 5 is a simplified block diagram of an environment of the emergency call handling server of the system of FIG. 1;

FIG. 6 is a simplified illustration of the location mapping database of the emergency call handling server of FIGS. 4 and 5;

FIG. 7 is a simplified illustration of the notification policy of the emergency call handling server of FIGS. 4 and 5;

FIG. 8 is a simplified map of a region serviced by the system of FIG. 1 and having multiple secure zones with corresponding mapped emergency numbers;

FIG. 9 is a simplified flow diagram of a method for registering with the emergency call handling server of FIGS. 4 and 5 that may be executed by the mobile communication device of FIGS. 2 and 3;

FIG. 10 is a simplified flow diagram of a method for updating available emergency numbers for a current location that may be executed by the mobile communication device of FIGS. 2 and 3;

FIG. 11 is a simplified flow diagram of a method for placing an emergency call that may be executed by the mobile communication device of FIGS. 2 and 3;

FIG. 12 is a simplified flow diagram of a method for registering the mobile communication device of FIGS. 2 and 3 that may be executed by emergency call handling server of FIGS. 4 and 5;

FIG. 13 is a simplified flow diagram of a method for updating available emergency number for a current location of the mobile communication device of FIGS. 2 and 3 that may be executed by emergency call handling server of FIGS. 4 and 5; and

FIG. 14 is a simplified flow diagram of a method for handing emergency calls received from the mobile communication device of FIGS. 2 and 3 that may be executed by emergency call handling server of FIGS. 4 and 5.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

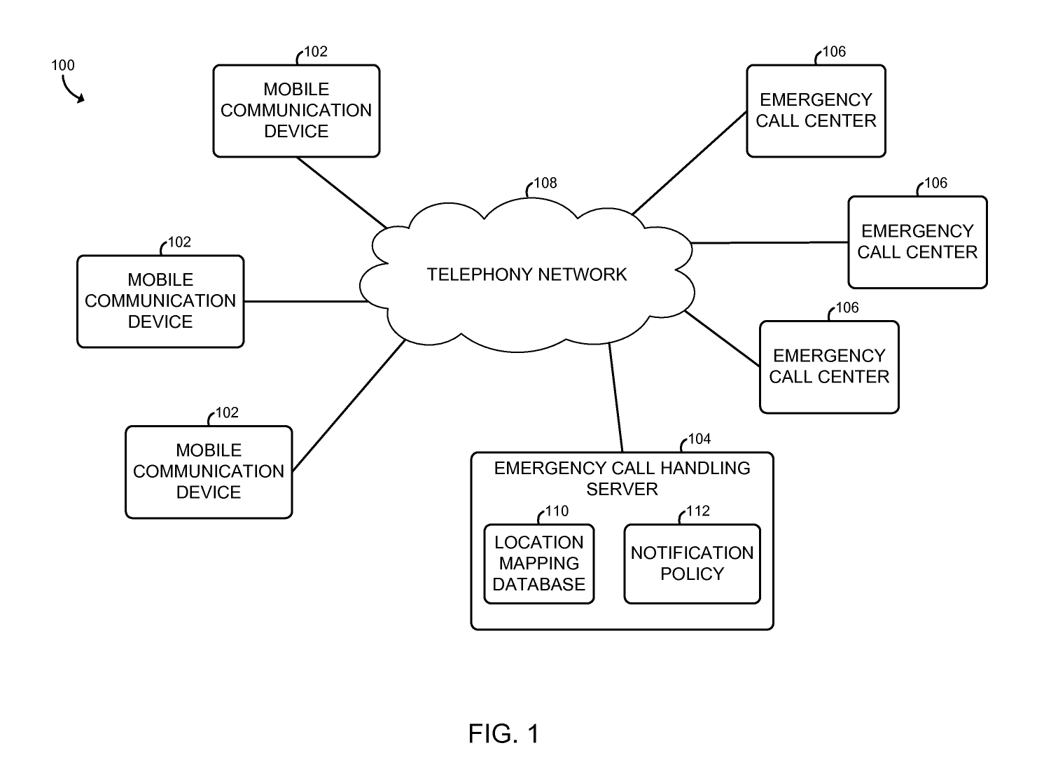

Referring now to FIG. 1, a system 100 for handling emergency calls from mobile communication devices includes one or more mobile communication devices 102, an emergency call handling server or switch 104, and one or more emergency call centers 106. The mobile communication devices 102, the emergency call handling server 104, and the emergency call centers 106 communicate with each other over a telephony network 108 to facilitate emergency calls originating from one of the mobile communication devices 102. The telephony network 108 may be embodied as, or otherwise include, a cellular communication network, a land line telephony network, and/or other telephony network to facilitate the communications between the devices of the system 100 as described in more detail below. Although only three mobile communication devices 102 and three emergency call centers 106 have been shown in the illustrative system of FIG. 1, it should be appreciated that in other embodiments the system 100 may include one, two, or more mobile communication devices 102 and/or emergency call centers 106.

It should also be appreciated that the handling of emergency calls originating from typical mobile communication devices, such as cellphones, can be difficult due the mobility of such devices. That is, emergency responders may be unable to pinpoint the precise location of the mobile communication device to which to send the emergency services or may otherwise take longer to do so. In the illustrative system 100, however, a user of one of the mobile communication devices 102 may originate an emergency call using a non-public emergency land line number, which has been assigned or mapped to a location or zone (e.g., the user's residence address). The non-public emergency land line number is embodied as a standard land line number that is not associated with a public emergency telephone number (e.g., not a “911” or other public emergency number). The emergency call from the mobile communication device 102 using the non-public emergency land line number is received by the emergency call handling server 104. Based on the particular emergency land line number called, the emergency call handling server 104 determines an appropriate emergency call center (e.g., the nearest police, medical, or fire call center based on the location associated with the called emergency land line number). To do so, the emergency call handling server 104 may compare the called non-public emergency land line number to a location mapping database 110 maintained by the emergency call handling server 104 to determine the pre-defined location.

The emergency call handling server 104 subsequently connects or routes the emergency call to the selected emergency call center 106 using the non-public emergency land line number. Additionally, in some embodiments, the emergency call handling server 104 may notify other entities (e.g., parents, neighbors, spouses, etc.) of the emergency by comparing the cellular telephone number of the calling mobile communication device 102 (and, in some embodiments, the called non-public emergency land line number), to a notification policy that maps the cellular telephone number to the entities to be notified. Such notifications may be embodied as texts, automated calls, and/or other notifications.

Because the non-public emergency land line number is associated with a pre-defined location, such as the user's residence address, the emergency responders of the selected emergency call center 106 are able to determine quickly the location of the emergency based on the pre-defined location. As such, even though the user of the mobile communication device may be located, for example, in a high-rise apartment building, the emergency call center 106 can identify the exact building in which the user lives (and, in some cases, the exact apartment number). Of course, the non-public emergency land line numbers are not restricted to user's residences. Rather, as discussed in more detail below, the emergency call handling server 104 may be configured to handle emergency calls from mobile communication devices 102 for other locations and/or emergency zones, which have been previously mapped to pre-defined locations.

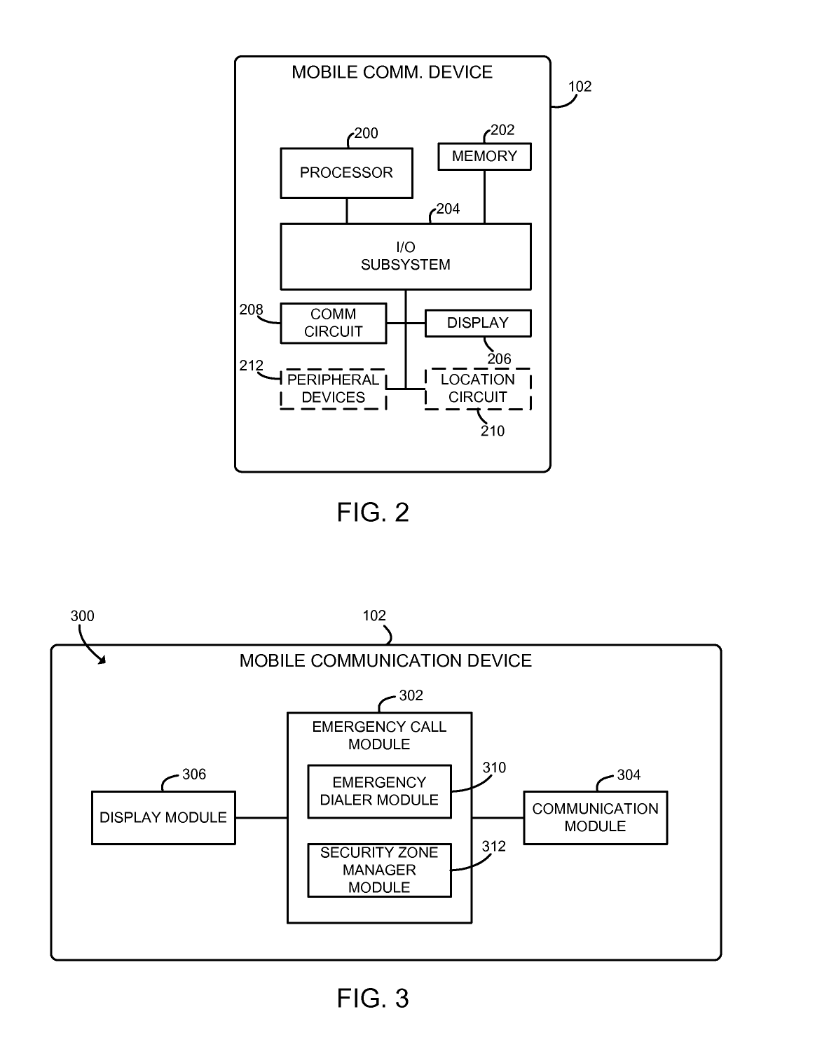

Referring now to FIG. 2, each of the mobile communication devices 102 may be embodied as any type of mobile communication device such as a “smartphone,” a cellular telephone, a tablet computer, a laptop computer, and/or other mobile communication device capable of communicating with the emergency call handling server 104 over the telephony network 108. As shown in FIG. 2, each illustrative mobile computing device 102 includes a processor 200, a memory 202, an input/output subsystem 204, a display 206, and a communication circuit 208. Of course, the mobile communication devices 102 may include other or additional components, such as those commonly found in mobile communication devices in other embodiments. Additionally, in some embodiments, one or more of the illustrative components may be incorporated in, or otherwise from a portion of, another component.

The processor 200 may be embodied as any type of processor capable of performing the functions described herein. For example, the processor 200 may be embodied as a single or multi-core processor(s), a digital signal processor, a microcontroller, or other processor or processing/controlling circuit. Similarly, the memory 202 may be embodied as any type of volatile or non-volatile memory or data storage capable of performing the functions described herein. In operation, the memory 202 may store various data and software used during operation of the mobile communication device 102 such as operating systems, applications, programs, libraries, and drivers. The memory 202 is communicatively coupled to the processor 200 via the I/O subsystem 204, which may be embodied as circuitry and/or components to facilitate input/output operations with the processor 200, the memory 202, and other components of the mobile communication device 102.

The display 206 of the mobile communication device 102 may be embodied as any type of display on which information may be displayed to a user of the mobile communication device 102. For example, the display 206 may be embodied as, or otherwise use, any suitable display technology including, for example, a liquid crystal display (LCD), a light emitting diode (LED) display, a cathode ray tube (CRT) display, a plasma display, and/or other display usable in a mobile communication device. Additionally, in some embodiments, the display 206 may be embodied as a touchscreen display and include an associated touchscreen sensor (not shown) to receive tactile input and data entry from the user.

The communication circuit 208 may be embodied as one or more devices and/or circuitry for enabling communications with the emergency call handling server 104 over the telephony network 108. For example, in the illustrative embodiment, the communication circuit 208 is embodied as a cellular communication circuit capable of facility cellular communications with the emergency call handling server 104 over the telephony network 108. The communication circuit 208 may be configured to use any suitable communication protocol to communicate with the emergency call handling server 104 over the network 108 including, for example, cellular communication protocols, wireless data communication protocols, and/or wired data communication protocols.

The mobile communication device 102 may also include a location circuit 210. The location circuit 210 may be embodied as any type of location-determination circuit capable of determining a current location of the mobile communication device 102. In the illustrative embodiment, for example, the location circuit 210 is embodied as a Global Positioning System (GPS) location-determination circuit configured to generate data indicative of the current location of the mobile communication device 102.

Additionally, in some embodiments, the mobile communication device 102 may further include one or more peripheral devices 212. Such peripheral devices 212 may include any type of peripheral device commonly found in a mobile communication device such as data storage, speakers, a hardware keyboard, input/output devices, peripheral communication devices, antennas, and/or other peripheral devices.

Referring now to FIG. 3, in use, the mobile communication device 102 establishes an environment 300. The illustrative environment 300 includes an emergency call module 302, a communication module 304, and a display module 306, each of which may be embodied as hardware, software, firmware, or a combination thereof.

The emergency call module 302 facilitates the origination of an emergency call on the mobile communication device 102 using the non-public emergency land line number. The illustrative emergency call module 302 includes an emergency dialer module 310 and an emergency zone manager module 312. The emergency dialer module 310 facilitates the dialing of the non-public emergency land line number based on a selection by the user. In some embodiments, the non-public emergency land line may be displayed to the user, via the display module 306, using some level of abstraction. For example, the non-public emergency land line number(s) may be saved in the user's contacts as simply “Emergency,” “Medical Emergency,” “Fire Emergency,” and so forth. Alternatively, in embodiments in which the mobile communication device 102 is embodied as a “smartphone,” the non-public emergency land line number(s) may be displayed to the user using display widgets, labels, or other indicia such as an “Emergency” widget, a “Medical Emergency” widget, and so on. In response to the user selecting the emergency widget or telephone number, the emergency dialer module 310 originates an emergency call to the associated non-public emergency land line number using the communication module 304.

As discussed above, the mobile communication device 102 may originate emergency calls for different locations in some embodiments. To facilitate such functionally, the emergency zone manager module 312 may control the display module 306 to display location identification data, widgets, labels, or other indicia (e.g., “Home,” “Lake House,” “School,” etc.) of locations or zones for which non-public emergency land line numbers have been established and are available to the user of the mobile communication device 102. In response to the user selecting a location widget, the emergency dialer module 310 may display the associated non-public emergency land line number(s) (or indicia thereof such as display widgets). That is, if the user selects “Home,” the emergency dialer module 310 may subsequently display a “Police Emergency” widget, a “Medical Emergency” widget, and/or a “Fire Emergency” widget, each of which is associated with a non-public emergency land line number for the selected location (i.e., for “Home”).

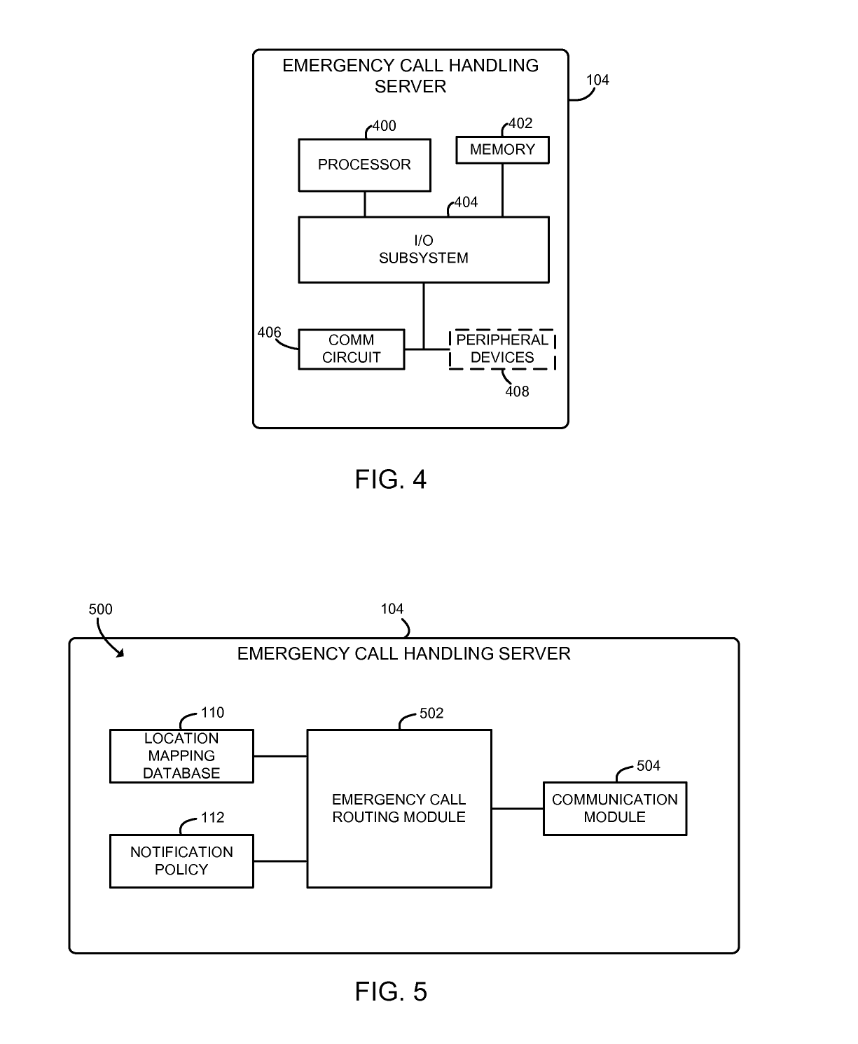

Referring now to FIG. 4, the emergency call handling server 104 may be embodied as any type of telephony switch or computing device capable of handling incoming emergency calls from the mobile communication devices 102 and connecting or routing such calls to the appropriate emergency call center 106 using the called non-public emergency land line number. In the illustrative embodiment of FIG. 4, the emergency call handling server 104 includes a processor 400, a memory 402, an I/O subsystem 404, a communication circuit 406, and additional peripheral devices 408. Each of the components of the emergency call handling server 104 may be similar to the corresponding components of the mobile communication devices 102 described above. As such, the description of the components of the mobile communication devices 102 applies equally to the corresponding components of the emergency call handling server 104 and is not repeated herein for clarity of the present disclosure.

Referring now to FIG. 5, in use, the emergency call handling server 104 establishes an environment 500. The environment 500 includes an emergency call routing module 502, a communication module 504, the location mapping database 110, and the notification policy 112. Each of the emergency call routing module 502 and the communication module 504 may be embodied as hardware, software, firmware, or a combination thereof.

The emergency call routing module 502 receives incoming emergency calls from the mobile communication devices 102 via the communication module 504. As discussed above, the emergency calls from the mobile communication devices 102 are placed to a non-public emergency land line number serviced by the emergency call handling server 104. The emergency call routing module 502 compares the called non-public emergency land line number to the location mapping database 110 to determine the location mapped to the non-public emergency land line number and selects an emergency call center 106 to receive the emergency call. The emergency call routing module 502 subsequently connects or routes the emergency call from the mobile communication device 102 to the selected emergency call center 106 using the called non-public emergency land line number, which has the pre-defined location attached to it such that the emergency responders of the selected emergency call center 106 can identify the location of the emergency.

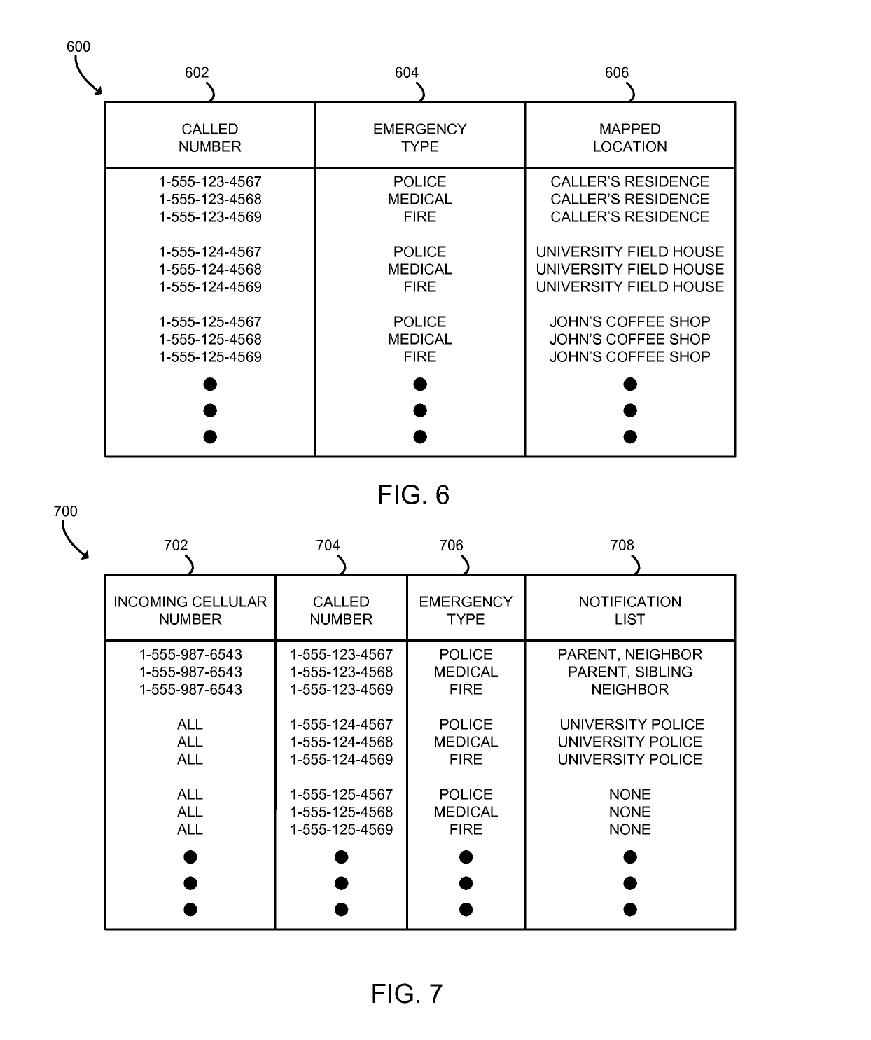

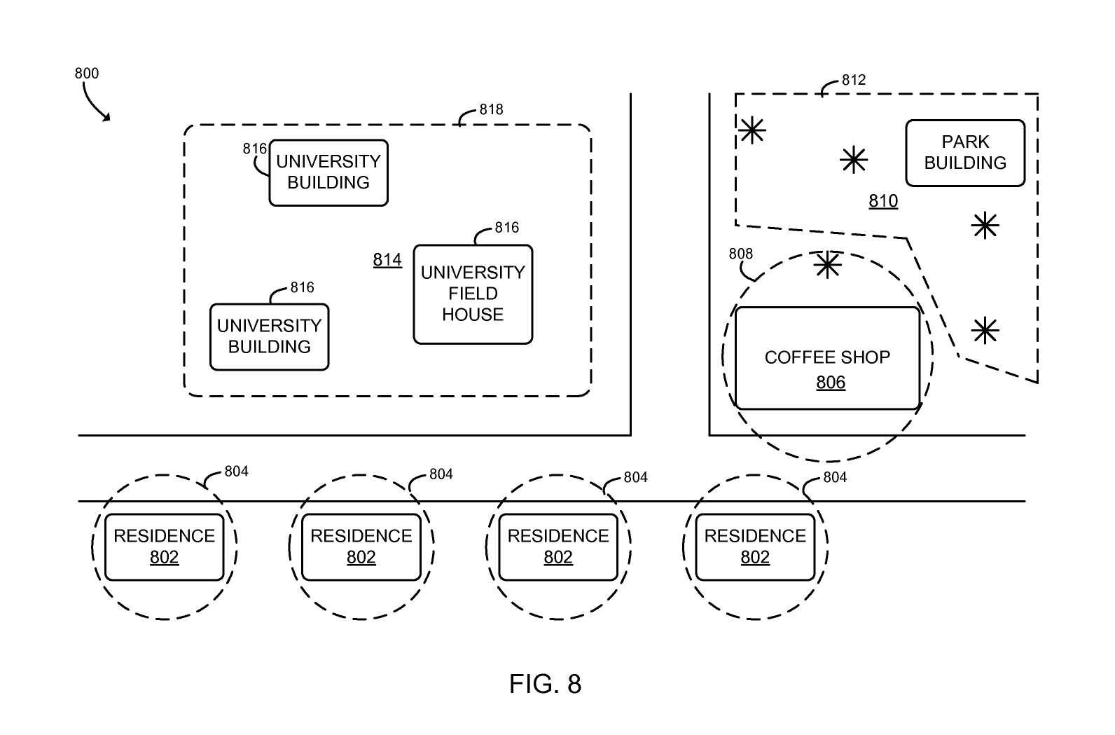

An illustrative embodiment of the location mapping database 110 is shown in FIG. 6. As discussed above, in the illustrative embodiment, the location mapping database maps non-public emergency land line numbers 602 to emergency types 604 and to mapped locations 606. As such, for each mapped location 606, multiple non-public emergency land line numbers may be assigned or mapped for different types of emergencies 604 (i.e., for different types of call centers 106 to handle the specific emergency type.) Additionally, as shown in FIG. 6, public facilities such as universities, stores, stadiums, parks, and other public and/or private locations or entities may utilize the system 100 to provide non-public emergency land line numbers to customers, visitors, or other users. As discussed above, each provided non-public emergency land line number has a pre-defined location, which may include a specific street address and/or other location information usable by the emergency responders of the emergency call center 106 to determine the location of the emergency. For example, an illustrative map 800 of location having multiple emergency zones is shown FIG. 8. Each emergency zone (shown as a dashed line) is embodied as a GPS-defined region having one or more non-public emergency land line numbers associated therewith. For example, each residence 802 may include an individual emergency zone 804 and have one or more non-public emergency land line numbers assigned to the emergency zone 804. As such, a registered user living at one of the residence 802 may use the mobile communication device 102 to originate an emergency call using one of the non-public emergency land line numbers assigned to the emergency zone of the user' residence 802. As discussed above, each of the assigned non-public emergency land line number also has a location associated therewith. In the case of the residences 802, the location defines the location of the residence (e.g., the street address, apartment number, etc. of the residence).

Of course, in addition to residences, businesses may offer access to non-public emergency land line numbers for that particular business. For example, a business 806 may include an individual emergency zone 808 (e.g., defined by GPS coordinates) and have one or more non-public emergency land line numbers assigned to the emergency zone 808 such that customers (or even a passerby) can originate an emergency call for the location of the business 806. Similarly, public spaces, such as a park 810 or a university 814 may include emergency zones 812, 818, respectively, that have associated non-public emergency land line numbers usable by guests, students, or other users to originate emergency calls using a mobile communication device 102. As discussed above, each non-public emergency land line number has a location associated therewith, such as the street address of the park 810, the street address of the university 814, the particular building number of the building 816 of the university 814 in which the emergency is occurring, room number, and/or other location identifying information usable by the emergency responders of the emergency call center 106 to determine the location of the emergency

Referring now back to FIG. 5, in addition to routing the emergency call received from the mobile communication device 102 to the selected emergency call center 106, the emergency call routing module may also be configured to generate a notification to one or more other entities to notify the entities about the emergency. To do so, the emergency call center 106 may access the notification policy 112 and determine which entities should be notified (and, in some embodiments, how to notify such entities) based on the cellular telephone number of the mobile communication device 102 and/or the called non-public emergency land line number. An illustrative embodiment of the notification policy 112 is shown in FIG. 7. The illustrative notification policy 112 maps the cellular telephone number 702 of the mobile communication device 102 and the called non-public emergency land line number 704, which is associated with a particular type of emergency 706, to a notification list 708. As shown in FIG. 7, the notification list 708 may identify any type of entity or party that is to be notified in the case of an emergency call. For example, the notification list 708 may instruct the emergency call routing module 502 to notify the caller's spouse, parent, neighbors, or other entity. Additionally, in the case in which the emergency zone applies to a place of business, public building, or other public space, the notification list may identify an entity (e.g., the campus police) which is to be notified of all calls placed to the non-public emergency land line number. Of course, it should be appreciated that other types of data structures and mapping may be used in the location mapping database 110 and/or the notification policy 112 in other embodiments.

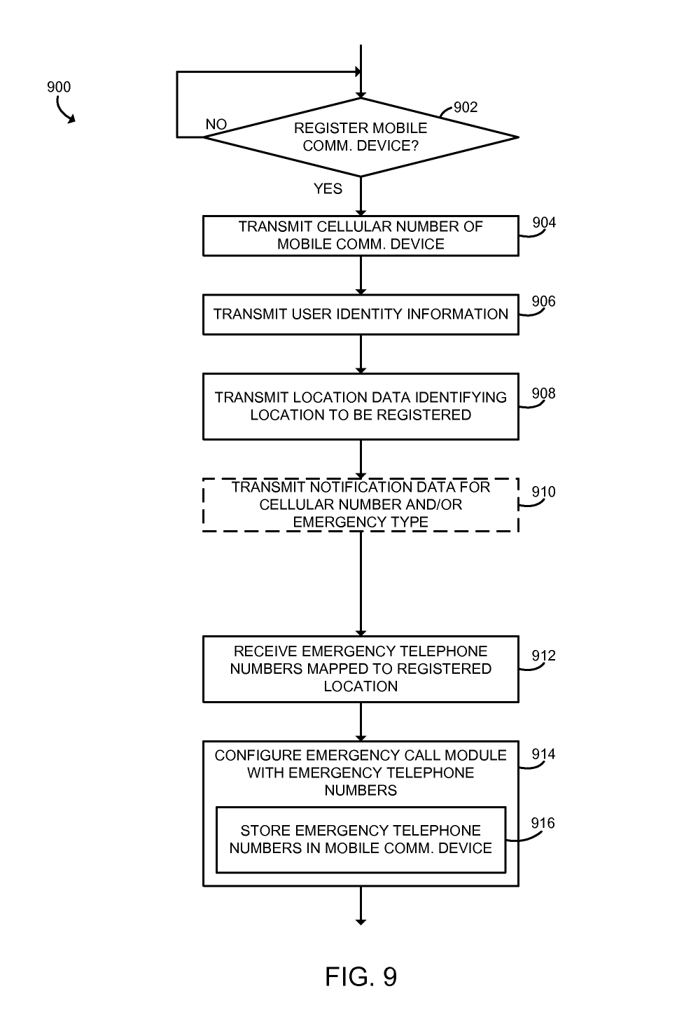

Referring now to FIG. 9, in use, each mobile communication device 102 may execute a method 900 to register with the emergency call handling server 104. The method 900 begins with block 902 in which the mobile communication device 102 determines whether the user desires to register with the emergency call handling server 104. If so, the method 900 advances to block 904 in which the user transmits the cellular number of the mobile communication device 102 that is to be registered. If the user is using the mobile communication device 102 to perform the registration, the cellular number of the mobile communication device 102 may be automatically detected or determined by the emergency call handling server 104 and, in such cases, the cellular number may not need to be actively transmitted to the server 104. However, in other embodiments in which the user is using a computer or other device to register the mobile communication device 102, the cellular number of the mobile communication device 102 may be transmitted or otherwise provided to the emergency call handling server 104 in block 904.

In block 906, the user transmits or supplies user identity information to the emergency call handling server 104. The user identity information may include any type of data or information that is useful to identify the user such as, for example, the user's name, social security information, payment information, residence address, and/or the like. Additionally, in block 908, the mobile communication device 102 transmits location data identifying the location to be registered. For example, the location data may identify the user's residence address, an address of a lake house of the user, or any other location for which the user of the mobile communication device 102 desires to have access to associated non-public emergency land line numbers serviced by the emergency call handling server 104. In some embodiments, the user may also submit or transmit notification data that identifies the entities to be notified in case of an emergency. As discussed above, the notification data may map entities to be notified based on the cellular telephone number of the mobile communication device 102 and/or the particular type of emergency (e.g., based on the called non-public emergency land line number associated with the particular emergency.

As discussed below, the emergency call handling server 104 determines the appropriate non-public emergency land line numbers that have been assigned to the registered location or emergency zone identified in block 908. The determined non-public emergency land line numbers are received by the mobile communication device 102 in block 912, and the emergency call module 302 of the mobile communication device 102 is configured with the received non-public emergency land line numbers in block 914. For example, the received non-public emergency land line numbers may be stored in the memory 202 of the mobile communication device 102 in block 916.

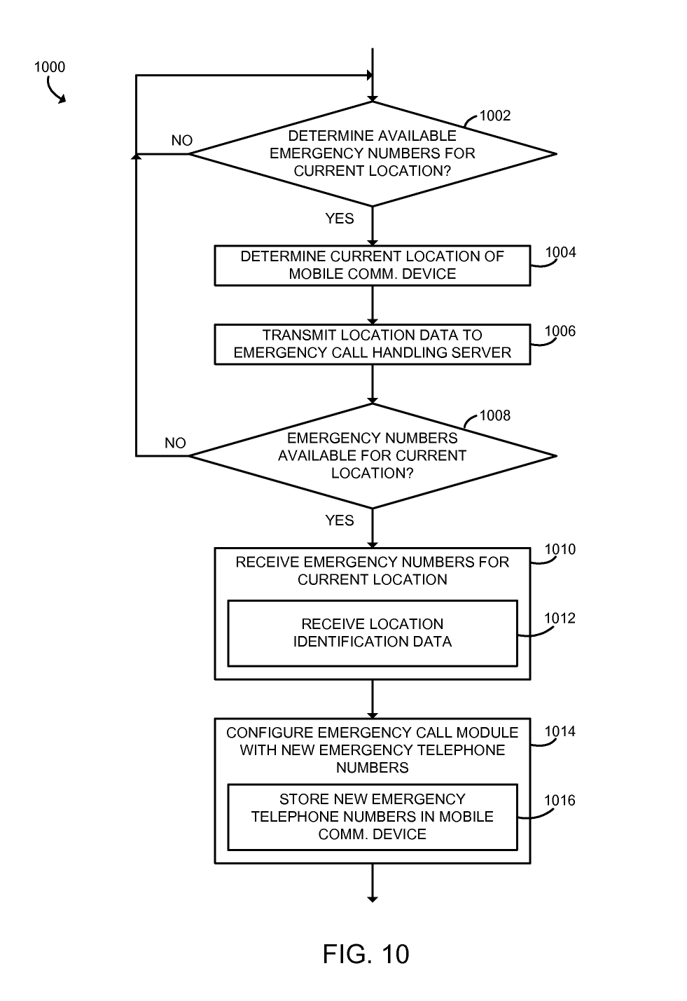

In addition to pre-registered locations and/or emergency zones, the mobile communication device 102 may also periodically access non-public emergency land line numbers assigned to other locations or emergency zones (e.g., the non-public emergency land line numbers assigned to the coffee shop 806 of FIG. 8). To do so, the mobile communication device 102 may execute a method 1000 for updating available emergency numbers for the current location of the mobile communication device 102 as shown in FIG. 10. The method 1000 begins with block 1002 in which the mobile communication device 102 determines whether the user desires to check on available non-public emergency numbers for the user's current location. For example, the user may select an option from a menu to instruct the mobile communication device 102 to do so. If so, the method 1000 advances to block 1004 in which the current location of the mobile communication device 102 is determined. As discussed above, in some embodiments, the mobile communication device 102 may include the location circuit 210 (e.g., a GPS circuit) that generated location data indicative of the current location of the mobile communication device 102. The location data is subsequently transmitted to the emergency call handling server 104 in block 1006. In block 1008, the mobile communication device 102 determines whether any non-public emergency numbers are available for the current location. If not, the method 1000 loops back to block 1002.

However, if non-public emergency numbers are available, the method 1000 advances to block 1010 in which the mobile communication device 102 receives the non-public emergency numbers from the emergency call handling server 104. Additionally, the mobile communication device 102 may receive location identification data from the emergency call handling server 104 in block 1012. The location identification data identifies the registered location or zone for which the received non-public emergency land line numbers have been assigned (e.g., “Park,” “University”, “John's Coffee Shop,” etc.). Subsequently, in block 1014, the emergency call module 302 of the mobile communication device 102 is configured with the received non-public emergency numbers. As discussed above, the received non-public emergency numbers may be stored in the memory 202 of the mobile communication device 102 in block 1016.

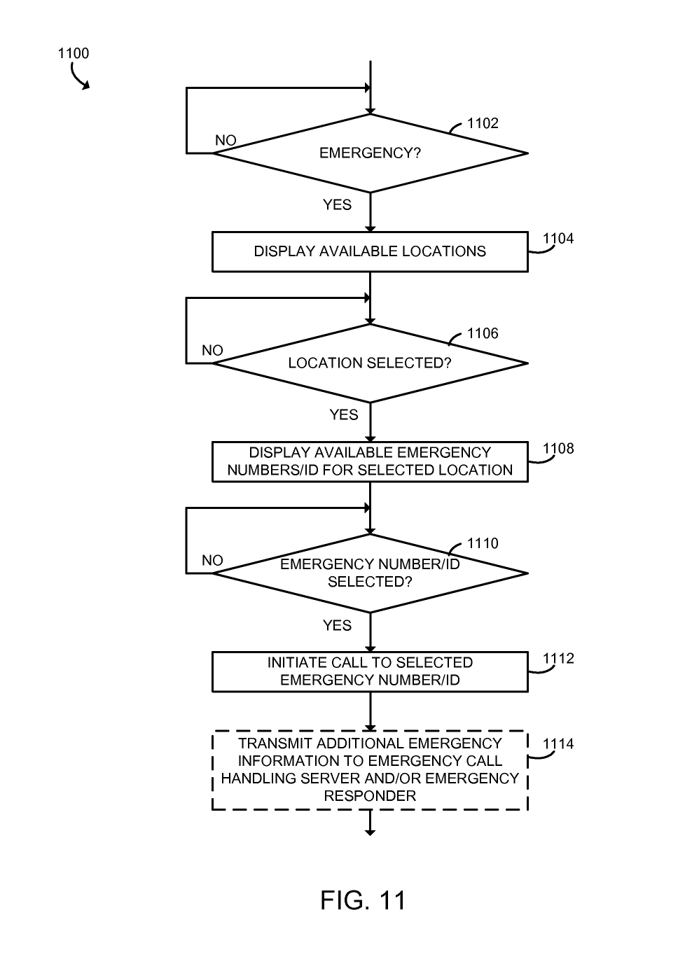

Referring now to FIG. 11, in use, the mobile communication device 102 may be operated by a user to initiate an emergency call using one of the non-public emergency numbers. To do so, the mobile communication device 102 may execute a method 1100 to originate such emergency call. The method 1100 begins with block 1102 in which the mobile communication device 102 determines whether the user desires to initiate an emergency call. The user may indicate such desire by selecting an application on the mobile communication device 102, selecting a graphical widget or label associated with the non-public emergency number, or the like.

In block 1104, the mobile communication device 102 displays the available registered locations to the user. For example, if the user has registered his/her residence and has registered the non-public emergency numbers for the local coffee shop, the mobile communication device 102 may display a graphical widget, label, or other indicia for each of the user's residence and the local coffee shop (e.g., “Home” and “Coffee Shop”). Regardless, the mobile communication device 102 determines whether the user has selected a location in block 1106. If so, the method 1100 advances to block 1108 in which the emergency numbers and/or identification labels/indicia are displayed to the user for the selected location. Of course, if the user has only one location or emergency zone registered with the mobile communication device 102, blocks 1104 and 1106 may be skipped.

In some embodiments, the mobile communication device 102 may display the non-public emergency numbers plainly and allow the user to select the desired number. However, in the illustrative embodiments, the mobile communication device 102 displays a graphical widget, label, or other indicia for each of the non-public emergency land line number associated with the selected location (e.g., “Police emergency,” “Medical Emergency,” etc.), which identify the particular type of emergency (and, thereby, the type of call center to route the emergency call to).

In block 1110, the mobile communication device 102 determines whether the user has selected one of the displayed non-public emergency call numbers. If so, the method 1100 advances to block 1112 in which the mobile communication device 102 initiates a call to the selected non-public emergency call number. Additionally, in some embodiments, the mobile communication device 102 may transmit additional emergency information to the emergency call handling server 104 and/or the emergency call center 106 in block 1114. Such additional emergency information may be vocally supplied by the user or may be supplied by selecting corresponding graphical widgets assigned with pre-defined messages (e.g., “I have fallen.”, “There is an intruder in my house.”, etc.).

It should be appreciated that the above-described methods facilitate the user of the mobile communication device 102 to place emergency calls from which emergency responders may determine a precise location of the emergency. That is, because each of the non-public emergency numbers has a pre-defined location associated with it, the emergency responders are able to determine such pre-defined location even though the call was originated from a mobile communication device 102. Further, it should be appreciated that the mobile communication device 102 need not necessarily be pre-registered with the emergency call handling server 104 to utilize the non-public emergency numbers offered by public businesses or locations.

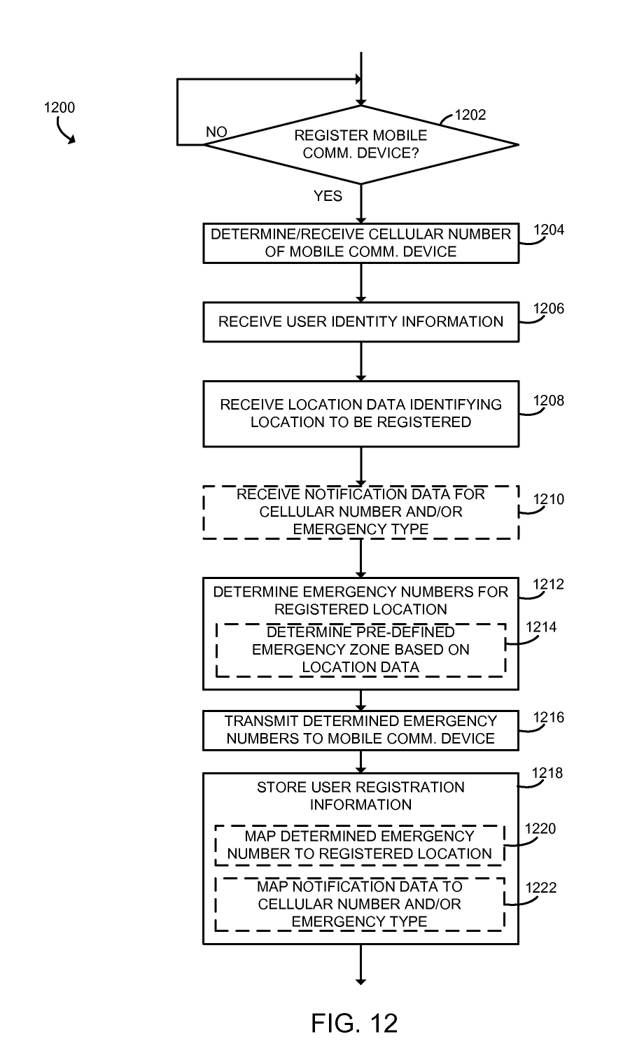

Referring now to FIG. 12, in use, the emergency call handling server 104 may execute a method 1200 to register each mobile communication device 102 of the system 100. The method 1200 begins with block 1202 in which the emergency call handling server 104 determines whether to register a mobile communication device 102. If so, the method 1200 advances to block 1204 in which the emergency call handling server 104 determines, or otherwise receives, the cellular number of the mobile communication device 102. That is, in embodiments in which the mobile communication device 102 is being used perform the registration process, the emergency call handling server 104 may automatically determine the cellular telephone number of the mobile communication device 102 based on the received call (i.e., via caller-ID). Regardless, in block 1206, the emergency call handling server 104 receives the user identity information. As discussed above, the user identity information may include any type of data or information that is useful in identity the user such as, for example, the user's name, social security information, payment information, residence address, and/or the like. Additionally, in block 1208, the emergency call handling server 104 receives the location data identifying the location to be registered. Again, as disclosed above, the location data may identify the user's residence address, an address of a lake house of the user, or any other location for which the user of the mobile communication device 102 desires to have access to associated non-public emergency land line numbers serviced by the emergency call handling server 104. Further, in some embodiments, the emergency call handling server 104 may also receive the notification data in block 1210. As discussed above, the notification data may map entities to be notified based on the cellular telephone number of the mobile communication device 102 and/or the particular type of emergency (e.g., based on the called non-public emergency land line number associated with the particular emergency.

In block 1212, the emergency call handling server 104 determines the non-public emergency land line numbers for the registered location received in block 1208. To do so, the emergency call handling server 104 may determine the pre-defined emergency zone or location based on the location data supplied by the user. For example, if the user supplies his/her residence address, the emergency call handling server 104 may determine a new set of non-public emergency numbers for the user's residence, which will subsequently be mapped to the non-public emergency numbers as discussed below. Alternatively, if the user supplies location data identifying a location already covered by an existing emergency zone, the emergency call handling server 104 will determine the existing non-public emergency numbers assigned to the emergency zone in block 1212.

Subsequently, in block 1216, the emergency call handling server 104 transmits the determined non-public emergency numbers to the mobile communication device 102. Additionally, in block 1218, the emergency call handling server 104 stores the user registration information. If the registered location is a new location or otherwise does not correlate to an existing emergency zone, the emergency call handling server 104 may map the determined non-public emergency land line numbers to the registered location (e.g., the user's residence address) in block 1220. Additionally, if the user supplied notification data in block 1210, the emergency call handling server 104 maps the notification data to the cellular number of the mobile communication device and/or the emergency type as discussed above.

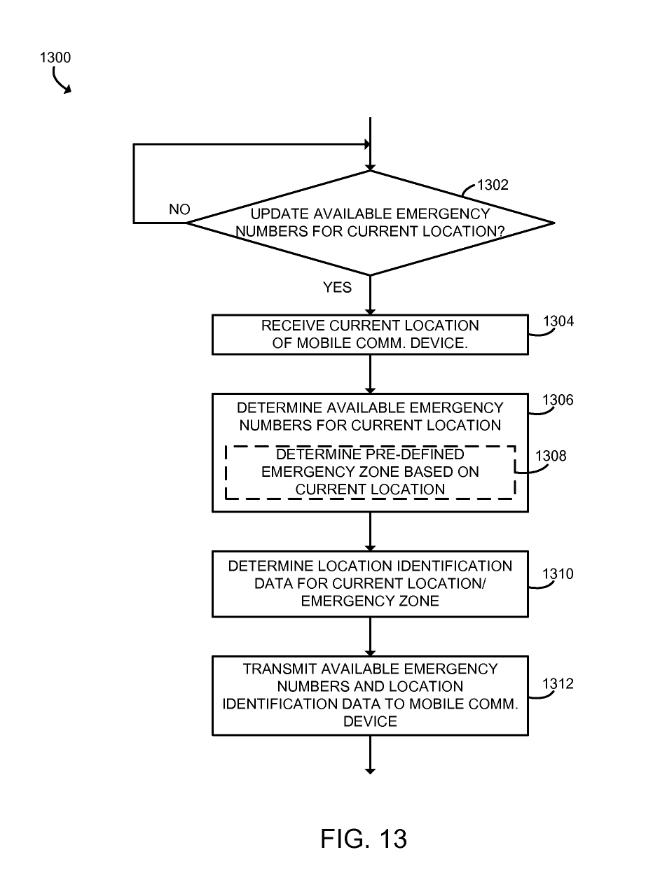

Referring now to FIG. 13, the emergency call handling server 104 may also periodically or responsively update the mobile communication device 102 with available non-public emergency numbers assigned to the current location of the mobile communication device 102. To do so, the emergency call handling server 104 may execute a method 1300 for updating the mobile communication device 102. The method 1300 begins with block 1302 in which the emergency call handling server 104 determines whether to update the mobile communication device 102 with available non-public emergency numbers. If so, the method 1300 advances to block 1304 in which the emergency call handling server 104 receives location data from the mobile communication device 102 that identifies the current location of the device 102. In block 1306, the emergency call handling server 104 determines whether any non-public emergency numbers are available for the current location of the mobile communication device 102. To do so, the emergency call handling server 104 may determine the pre-defined emergency zone, which has one or more non-public emergency numbers assigned thereto, based on the current location of the mobile communication device 102. For example, the user may be visiting the local coffee shop 806 (see FIG. 8) and see an emergency occur. In response, the user may operate his/her mobile communication device 102 to access the non-public emergency numbers assigned to the local coffee shop 806 to facilitate the reporting of the emergency. Of course, the user may also pre-register the non-public emergency numbers assigned to the local coffee shop 806 such that the mobile communication device 102 is pre-configured to use such emergency numbers. Regardless, it should be appreciated that by using the non-public emergency numbers assigned to the local coffee shop 806, the emergency responders of the selected emergency call center 106 will be able to determine the location of the emergency (based on the pre-defined location associated with the called non-public emergency number) without the need of the user attempting to describe or determine his/her location (e.g., the address of the coffee shop 806).

Subsequently, in block 1310, the emergency call handling server 104 determines any location identification data for the current location (or determined emergency zone of the current location) of the mobile communication device 102. As discussed above, the location identification data identifies the registered location or emergency zone for which the received non-public emergency land line numbers have been assigned (e.g., “Park,” “University”, “John's Coffee Shop,” etc.). In block 1312, emergency call handling server 104 transmits the available emergency numbers and associated location identification data to the mobile communication device 102.

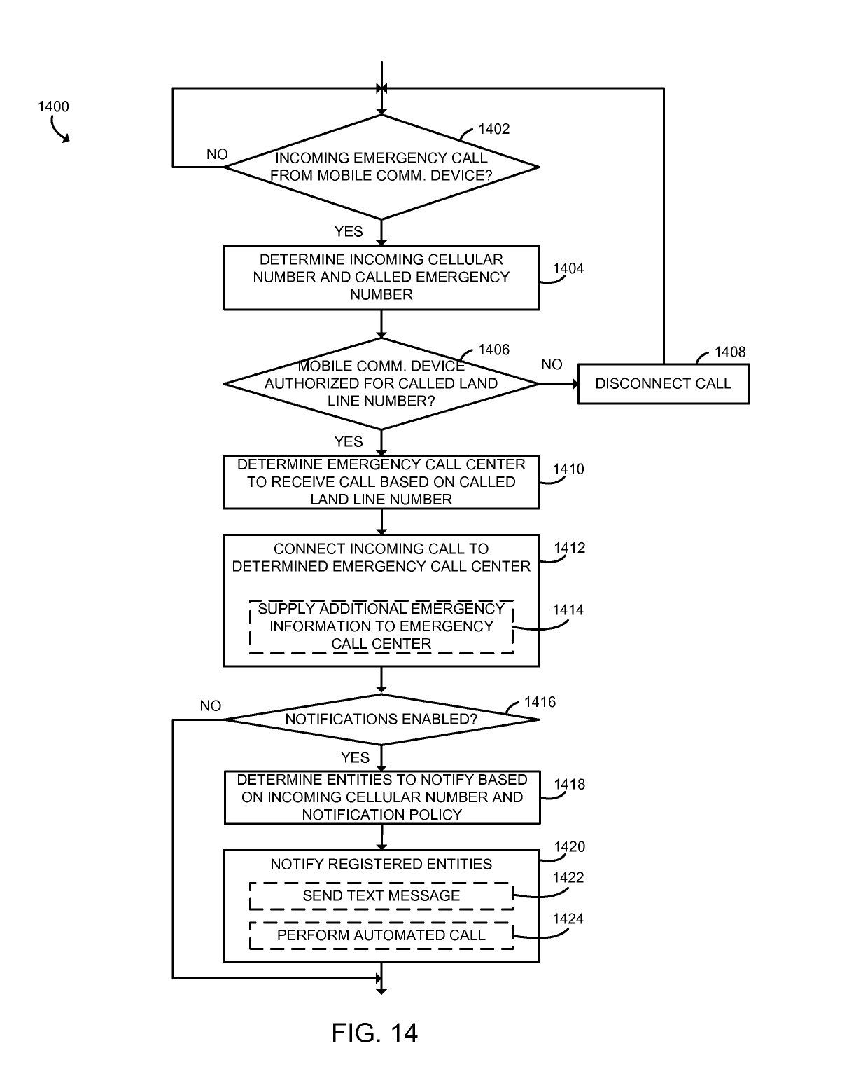

Referring now to FIG. 14, in use, the emergency call handling server 104 may execute a method 1400 to handle emergency calls received from one of the mobile communication devices 102 of the system 100. The method 1400 begins with block 1402 in which the emergency call handling server 104 determines whether an incoming call has been received from one of the mobile communication devices 102. If so, the method 1400 advances to block 1404 in which the emergency call handling server 104 determines the incoming cellular number of the mobile communication device 102 originating the emergency call and the called non-public emergency land line number. To do so, the emergency call handling server 104 may utilize any suitable methodology and/or technology, such as caller-ID, to determine such information.

In block 1406, the emergency call handling server 104 determines whether the mobile communication device 102 is authorized to place an emergency call using the called non-public emergency land line number. To do so, the emergency call handling server 104 may analyze the cellular number of the calling mobile communication device 102. If the mobile communication device 102 is not authorized to place an emergency call using the called non-public emergency number, the method 1400 advances to block 1408 in which the current call is disconnected. In this way, non-authorized individuals cannot make fake emergency calls using the non-public emergency land line numbers.

If, however, the mobile communication device 102 is authorized to make the emergency call, the method 1400 advances to block 1410. In block 1410, the emergency call handling server 104 determines or selects the emergency call center 106 to handle the emergency call. To do so, for example, the emergency call handling server 104 may select the emergency call center 106 based on the pre-defined location associated with the called non-public emergency land line number (e.g., select the nearest emergency call center 106). Additionally, the emergency call handling server 104 may select the emergency call center 106 based on the type of emergency (e.g., based on the particular non-public emergency land line number called). Subsequently, in block 1412, the emergency call handling server 104 routes, or otherwise connects, the emergency call to the selected emergency call center 106 using the called non-public emergency land line number such that the selected emergency call center 106 is capable of determining the location of the emergency based on the pre-defined location associated with the called non-public emergency land line as discussed above. In embodiments in which additional emergency information is supplied by the user of the mobile communication device 102, such additional emergency information is provided to the selected emergency call center in block 1414.

In block 1416, the emergency call handling server 104 determines whether notifications have been enabled for the calling mobile communication device 102 and/or the called non-public emergency number. If so, the method 1400 advances to block 1418 in which the emergency call handling server 104 determines which entities to notify based on the notification policy. As discussed above, the emergency call handling server 104 may compare the incoming cellular number of the mobile communication device 102 and/or the called non-public emergency number to the notification policy. Subsequently, in block 1420, the emergency call handling server notifies the registered entities (e.g., “Parent,” “Neighbor,” etc.) using contact information stored in the notification policy 112. For example, in block 1422, the emergency call handling server 104 may generate a text message to a registered entity and/or initiate an automated call to a registered entity in block 1424. Of course, the emergency call handling server 104 may utilize other methodologies and/or technologies to notify entities based on the notification policy in other embodiments.

1. A method for handling an emergency call, the method comprising:
receiving, with an emergency call handling server, an emergency call originated by a mobile communication device to a land line number serviced by the emergency call handling server, the land line number having a pre-defined location associated therewith;
determining, with the emergency call handling server, an emergency call center to receive the emergency call based on the land line number; and
routing the emergency call to the selected emergency call center using the land line number.

2. The method of claim 1, wherein:
receiving the emergency call comprises receiving an emergency call to a land line number mapped to a particular emergency type; and
determining the emergency call center comprises determining the emergency call center based on the emergency type mapped to the land line number.

3. The method of claim 1, wherein determining the emergency call center comprises comparing the land line number called by the mobile communication device to a location mapping database, the location mapping database mapping land line numbers to pre-defined locations.

4. The method of claim 1, wherein routing the emergency call comprises conveying the pre-defined location to the emergency call center using the land line number.

5. The method of claim 1, further comprising receiving additional emergency information related to an emergency prompting the emergency call from the mobile communication device and supplying the additional emergency information to the emergency call center.

6. The method of claim 1, further comprising:
determining whether the mobile communication device is authorized to originate the emergency call using the land line number; and
disconnecting the emergency call prior to routing the emergency call to the selected emergency call center in response to determining that the mobile communication device is not authorized to originate the emergency call using the land line number.

7. The method of claim 1, further comprising:
determining, with the emergency call handling server, an entity to notify by comparing a cellular telephone number of the mobile communication device to a notification policy stored on the emergency call handling server, the notification policy mapping incoming cellular telephone numbers to entities to be notified; and
notifying the determined entity in response to receiving the emergency call.

8. The method of claim 7, wherein determining the entity to notify comprises comparing the land line number to the notification policy.

9. The method of claim 1, wherein determining the emergency call center to receive the emergency call comprises determining a first emergency call center to receive the emergency call, and further comprising:
receiving, with the emergency call handling server, a second emergency call originated by the mobile communication device to a second land line number;
determining, with the emergency call handling server, a second emergency call center to receive the second emergency call based on the second land line number; and
routing the second emergency call to the second emergency call center using the second land line number.

10. The method of claim 9, wherein the second land line number is associated with the pre-defined location.

11. The method of claim 9, wherein the second land line number is associated with a second pre-defined location different from the pre-defined location associated with the first land line number.

12. An emergency call handling server to handle emergency calls originated from mobile communication devices, the emergency call handling server comprising:
a communication module to receive an emergency call originated by the mobile communication device to a land line number serviced by the emergency call handling server, the land line number having a pre-defined location associated therewith; and
an emergency call routing module to (i) determine an emergency call center to receive the emergency call based on the land line number and (ii) route the emergency call to the selected emergency call center using the land line number.

13. The emergency call handling server of claim 12, wherein to receive the emergency call comprises to receive an emergency call to a land line number mapped to a particular emergency type; and
wherein to determine the emergency call center comprises to determine the emergency call center based on the emergency type mapped to the land line number.

14. The emergency call handling server of claim 12, further comprising a location mapping database that maps land line numbers to pre-defined locations, and
the emergency call routing module is to compare the land line number called by the mobile communication device to the location mapping database to determine the emergency call center.

15. The emergency call handling server of claim 12, wherein the emergency call routing module is further to:
determine whether the mobile communication device is authorized to originate the emergency call using the land line number; and
disconnect the emergency call prior to routing the emergency call to the selected emergency call center in response to a determination that the mobile communication device is not authorized to originate the emergency call using the land line number.

16. The emergency call handling server of claim 12, further comprising a notification policy that maps incoming cellular telephone numbers to entities to be notified, and
wherein the emergency call routing module is further to (i) determine an entity to notify by comparison of a cellular telephone number of the mobile communication device to the notification policy and (ii) notify the determined entity in response to receipt of the emergency call.

17. The emergency call handling server of claim 12, wherein the emergency call comprises a first emergency call, the land line number comprises a first land line number, and the emergency call center comprises a first emergency call center, and
the communication module is further to receive a second emergency call originated by the mobile communication device to a second land line number, and
the emergency call routing module is further to (i) determine a second emergency call center to receive the second emergency call based on the second land line number and (ii) route the second emergency call to the second emergency call center using the second land line number.

18. The emergency call handling server of claim 17, wherein the second land line number is associated with the pre-defined location.

19. The emergency call handling server of claim 17, wherein the second land line number is associated with a second pre-defined location different from the pre-defined location associated with the first land line number.

20. A method for originating an emergency call on a mobile communication device, the method comprising:
displaying a plurality of location identifications on a display of the mobile communication device, each location identification being associated with a corresponding location;
receiving, with the mobile communication device, a user selection of one of the location identifications;
determining, with the mobile communication device, a plurality of emergency type identifications based on the selected location identification, each emergency type identification having a non-public-emergency land line number associated therewith;
displaying the plurality of emergency type identifications on the display of the mobile communication device;
receiving a user selection of one of the emergency type identifications; and
originating a call to the non-public-emergency land line number associated with the selected emergency type identification to complete an emergency call.
